(19) United States
(12) Patent Application Publication
(10) Pub. No.: US 2019/0134903 A1
(43) Pub. Date: May 9, 2019

(54) HEATING LAMP CALIBRATION

(71) Applicant: HEWLETT-PACKARD DEVELOPMENT COMPANY, L.P., Houston, TX (US)

(72) Inventors: Alejandro Manuel De Pena, Sant Cugat del Valles (ES); Sergio Puigardeu Aramendia, Corvallis, OR (US); Jordi Sanroma Garrit, Sant Cugat del Valles (ES)

(73) Assignee: HEWLETT-PACKARD DEVELOPMENT COMPANY, L.P., Houston, TX (US)

(21) Appl. No.: 16/094,246

(22) PCT Filed: May 12, 2016
(86) PCT No.: PCT/US2016/032100

§ 371 Date: Oct. 17, 2018

(51) Int. Cl. B29C 64/295; B29C 35/02; B29C 35/08; B29C 64/165; B29C 64/393

(52) U.S. Cl. CPC B29C 64/295; B29C 35/0288; B29C 35/0805; B29C 2037/90; B29C 64/393; B29C 2035/0822; B29C 2035/0855; B29C 64/165

(57) ABSTRACT

In one example, a system for heating lamp calibration can include a plurality of heating lamps over a print bed to heat the print bed over a period of time, a thermal imaging sensor to capture images of the print bed over the period of time, and a computing device coupled to the thermal imaging sensor to determine a surface flux delivered to each of a plurality of zones of the print bed over the period of time and calibrate a heating lamp of the plurality of heating lamps based on a corresponding contribution to the surface flux.

### BACKGROUND

Additive manufacturing systems may manufacture three-dimensional (3-D) objects by utilizing a mechanism of successively distributing a material to build up a three-dimensional (3-D) object. The additive manufacturing mechanism may include selectively distributing agents onto a build material to effect the buildup of the 3-D object. 3-D printers may utilize such a mechanism to additively manufacture 3-D objects. 3-D printed objects may be additively manufactured based on a three-dimensional object model.

### BRIEF DESCRIPTION OF THE DRAWINGS

FIG. 1 illustrates a diagram of an example of a system for heating lamp calibration according to the present disclosure.

FIG. 2 illustrates a diagram of an example of a computing device according to the present disclosure.

FIG. 3 illustrates a diagram of an example of a system for generating a weighting matrix for heating lamp calibration according to the present disclosure.

FIG. 4 illustrates a flow chart of an example of a method of fuse lamp calibration according to the present disclosure.

FIG. 5 illustrates an example sequence of operations to calibrate the heating lamps according to the present disclosure.

### DETAILED DESCRIPTION

The present application relates to systems, devices, and computer readable medium for heating lamp calibration. In one example, a system for heating lamp calibration may include a plurality of heating lamps over a print bed to heat the print bed over a period of time, a thermal imaging sensor to capture images of the print bed over the period of time. In addition, the system may comprise a computing device coupled to the thermal imaging sensor to determine a surface flux delivered to each of a plurality of zones of the print bed over the period of time, and calibrate a heating lamp of the plurality of heating lamps based on a corresponding contribution to the surface flux. In some examples, the systems, devices, and computer readable medium for heating lamp calibration may be utilized to ensure that a plurality of heat lamps of a heat lamp array fixed over a print bed are maintaining a substantially homogenous temperature (e.g., within plus or minus two degrees Celsius) across a print bed surface, determine degradation of the plurality of heat lamps, and/or determine when obstructions (e.g., dust, dirt, building material, etc.) exist between the plurality of heat lamps and the print bed.

In some examples, the systems, devices, and computer readable medium described herein may be utilized with additive manufacturing techniques or devices such as three-dimensional (3-D) printing devices. The 3-D printing devices may selectively distribute an agent on a print bed (e.g., build area). An agent (which may also be referred to as a coalescing agent or a fusing agent) may be an agent that modulates energy absorption of a different material such as a build material and/or transforms the properties of the different material. The build material may be a material that may be transformed into the 3-D object. The build material may be, for example, a semi-crystalline thermoplastic powder, which may melt and then solidify. In other examples, the build material may include a paste, a gel, a slurry, etc. For example, the agent may include a fusing agent that acts as an energy absorber to transfer an increased quantity of applied energy to the second material relative to untreated build material. In an example, the fusing agent may be a liquid material that absorbs radiation applied by an energy source of the additive manufacturing device (e.g., absorbs particular wavelengths of radiation applied from a heat source, which may be within and/or outside of the visible spectrum). The fusing agent may, in an example, be a dark colored (e.g., black) thermal absorber and/or a colorless thermal absorber (e.g., Ultraviolet (UV) absorbers). In some examples, the agent may also include detailing agents that act as energy absorption retarding agents and/or a moderating agent that modifies a degree of coalescence of the build material.

In some examples, the 3-D printing device may include a plurality of heat sources (e.g., overhead heating lamps, fusing lamps, infrared lamps, microwave lamps, etc.). Some of the heating sources, such as the fusing lamps, may be located on a carriage that traverses the print bed to apply energy to the print bed and/or the build material. Some of the heating sources, such as the overhead heating lamps, may be mounted to a substantially fixed assembly located over the print bed. The heating lamps mounted to the fixed assembly may be zenithal radiant heaters.

The 3-D printing device may solidify portions of the build material by applying energy (e.g., heat energy, radiation energy, radiated energy, etc.) to the build material. For example, the device may apply energy to the build material in order to cause the build material to fuse or sinter (e.g., to melt, coalesce, and solidify from powder). The energy may be applied from a heat source. For example, a portion of the energy may be applied by a lamp (e.g., an array of overhead heating lamps, an array of near infrared lamps, an array of near infrared lamps situated above the build area) and/or a conductive resistive heating source in a print bed. In another example, a portion of the energy may be applied by a fuse lamp coupled to a carriage.

The energy applied by the overhead heating lamps may be absorbed by portions of the build material. The absorbed energy may heat the portions of the build material. The absorbed energy may influence the temperature of the build material.

The build material may have a very sharp melting point where the material transitions from solid to liquid within a narrow temperature range. When the build material cools below the melting point it may reach a recrystallization point where it will recrystallize. Therefore, the build material may be associated with a specific process window. The process window may be a temperature window between the melting point and the recrystallization point. It may be desirable to operate the print bed of the 3-D printing device in the process window since operating the print bed at a temperature above the melt point would melt the build material across the entire print bed and operating the print bed at a temperature below the recrystallization point may cause part quality degradation through uneven recrystallizing events. In some examples the process window may range from three to five degrees Celsius to around ten to fifteen degrees Celsius depending on the type of build material utilized.

Operating the print bed within the process window may include modulating and/or controlling the temperature of build material on the surface of the print bed. In an example, the temperature of the build material may be determined based on the temperature at a surface, such as the upper-most surface of the build material. The temperature of the build material on the print bed may not be homogenous. However, it may be desirable to achieve and/or maintain a substantially homogenous temperature of the build material on the print bed to maintain operation of the print bed within the process window. The obtainment and maintenance of the build material temperature may be achieved and or maintained through the use of the overhead heating lamps and/or various other heating mechanisms such as a conductive resistive heating source in the print bed. The overhead heating lamps and conductive resistive heating sources may influence the temperature of the building material by applying energy to the print bed and/or building material in the manner described herein.

However, maintaining the build material within a process window may not be as simple as operating, for example, a heating lamp according to manufacturer's specifications and/or assembly line calibration specifications to introduce a known and constant amount of energy to the build material to generate a known and constant amount of temperature influence on the build material. That is, the temperature of the build material on the print bed may be influenced by a variety of variables that may be dynamic and may not be characterized by manufacturers specifications or assembly line calibration specifications. For example, components of 3-D printing device may degrade with use, age, mechanical stresses, environmental stresses, etc. For example, physical properties and/or corresponding behaviors or outputs of physical components of an overhead heating lamp array may degrade and this degradation may influence the energy that the overhead heating lamp may deliver to the build material. The energy output of a lamp itself may be modified with use such that it is operating outside of specifications. As a result, constituent overhead heating lamps of an overhead heating lamp array may begin to introduce a disproportionate and/or unpredicted amount of energy to the build material.

Moreover, the overhead heat lamps of a 3-D printing device may be separated from the print bed of the 3-D printing device by at least a protective sheet of material such as glass. The protective sheet of material may serve to mitigate explosion risk and/or protect the heating lamps from environmental influences such as dust, debris, and/or other obstructions. The protective sheet of material may degrade. For example, the optical qualities such as the transmittance of the protective sheet may be altered through exposure to the radiation of the overhead heat lamps and/or environmental conditions including the accumulation of obstructions thereupon. As such, the delivery of a portion of the energy generated by the overhead heating lamp array may be altered by the degraded protective sheet.

In another example, properties of the build material itself and/or of the application of the build material to the print bed may influence the effect of a quantity of energy upon the temperature of the build material. For example, the irradiance and/or emissivity of the build material, the thickness of a layer of build material selectively distributed on the print bed, and/or the density of the build material selectively distributed on the print bed may influence the effect of a quantity of energy upon the temperature of the build material.

In another example, atmospheric conditions may influence the effect of a quantity of energy upon the temperature of the build material. For example, the atmospheric conditions of the print bed and/or a build chamber including the print bed may affect the temperature of the build material. The atmospheric conditions may include the ambient temperature over the build chamber, the ambient temperature within the build chamber, the ambient temperature of the host environment of the 3-D printing device, the air flow over the print bed and/or in a build chamber, the humidity over the print bed and/or in a build chamber, and/or conditions in an artificial atmosphere (e.g., purged nitrogen atmosphere build chamber). The physical properties of various atmospheric conditions may influence the effect of a quantity of energy upon the temperature of the build material by altering the transmission of the energy to, from, and across the build material.

In yet another example, the spatial distribution of components of the 3-D printing device may influence the effect of a quantity of energy upon the temperature of the build material. For example, the particular arrangement of the overhead heating lamps within an overhead heating lamp array assembly may influence how much energy is delivered to a particular portion of the build material.

The example variables described above and others may produce a heterogeneous effect on the conditions at the print bed and/or the build material thereupon. The result may include heterogeneous conditions, such as temperature, at the print bed and/or the build material of the 3-D printing device. The resulting heterogeneous conditions may result in thermal gradients across the build material on the print bed. Thermal gradients across the build material may include spatial temperature differences existing in the build material across a print bed. Thermal gradients across the build material may affect the quality of parts produced by 3-D printing operations. For example, if distinct portions of the build material are outside the process window then the distinct portions may reach melting points and/or recrystallization points at different times. Even if distinct portions of the build material are within the process window but have heterogeneous temperatures the distinct portions may reach melting points and/or recrystallization points at different times. As a result, the part being formed from the build material may have distinct portions that reach melting points and/or recrystallization points at different times. The temporal heterogeneity of reaching a melting point and/or recrystallization point may generate mechanical stresses within the part leading to part quality degradation which may manifest as warpage, relative weakness, geometric inaccuracies, etc. of the part.

The heterogeneous effect may be one that is not able to be predicted or modeled, and therefore calibrated for, in advance of the end-user operation. That is, the influence of degradation of 3-D printing device components and the various other variables on the effect of a quantity of energy upon the temperature of the build material unique to a particular 3-D printing device in an operating environment may not be able to be predicted with an accuracy that would allow an accurate corrective overhead heating lamp calibration during manufacturing.

FIG. 1 illustrates a diagram of an example of a system 100 for heating lamp calibration according to the present disclosure. The system 100 may include a database 104, a calibration manager 102, and/or a number of engines (e.g., thermal image engine 106, surface flux engine 108, calibrate engine 110). The calibration manager 102 may be in communication with the database 104 via a communication link, and may include the number of engines (e.g., thermal image engine 106, surface flux engine 108, calibrate engine 110). The calibration manager 102 may include additional or fewer engines than are illustrated to perform the various functions as will be described in further detail.

The number of engines (e.g., thermal image engine 106, surface flux engine 108, calibrate engine 110) may include a combination of hardware and programming, but at least hardware, that is to perform functions described herein (e.g., receive a plurality of images of the print bed captured by the thermal imaging sensor over a period of time, determine a surface flux delivered to each of a plurality of zones of the print bed over the period of time, calibrate a heating lamp based on a corresponding contribution to the surface flux, etc.) as well as hard-wired programs (e.g., logic).

The thermal image engine 106 may include hardware and/or a combination of hardware and programming, but at least hardware, to receive a plurality of thermal images of a print bed captured over a period of time. In some examples, the thermal image engine 106 may receive thermal images from a thermal imaging sensor (e.g., sensor that may capture thermal images, thermal camera, etc.). In some examples, the thermal images may be received from a thermal camera coupled to a 3-D printing device. For example, a 3-D printing device may utilize an overhead thermal imaging camera that may capture thermal images of the print bed. In some examples, the thermal imaging sensor may be positioned within an overhead heating lamp array assembly positioned above the print bed. In some examples, the thermal imaging sensor may be positioned above the carriage of the 3-D printing device. In these examples, the thermal imaging sensor may capture thermal images of the print bed when the carriage is not between the thermal imaging camera and the print bed. The thermal imaging sensor may provide a thermal map of the print bed comprising temperatures of the print bed and/or the build material selectively distributed thereupon at a plurality of locations simultaneously. While a point measuring device may be utilized to capture the temperature at a particular location on the print bed and/or build material, the thermal imaging sensor may provide the temperature data corresponding to substantially every location of the print bed and/or build material simultaneously. In some examples, the print bed may include a calibration surface. A calibration surface may include the bare surface of the print bed without any build material thereupon. The bare surface of the print bed may include particular coloration (e.g., colors or patterns corresponding to various types of build material, detailing agents, and/or fusing agents). The calibration may additionally include a calibration plate. A calibration plate may include a plate that may be placed on top of the print bed surface. The calibration plate may include a particular coloration (e.g., colors or patterns corresponding to the coloration of various types of build material, detailing agents, and/or fusing agents) and may be made up of particular materials with known irradiance, emissivity, and/or other thermal properties (e.g., properties corresponding to properties of various types of build material and/or fusing agents).

The overhead heating lamp array assembly may be positioned substantially directly above the print bed and/or a printing chamber confining a print bed. The overhead heating lamp array assembly may include a plurality of heating lamps positioned over the print bed. The plurality of heating lamps may be arranged in various configurations throughout the assembly. For example, a first portion of the heating lamps may be arranged in a first orientation within the assembly and a second portion of the heating lamps be arranged in a second orientation that is perpendicular to or otherwise non-parallel to the first portion of heating lamps. The spacing of heating lamps in the assembly may range from substantially regular to substantially irregular.

As described above, the thermal imaging sensor may capture a plurality of images of the print bed over a period of time. Each of the plurality of images may correspond to the temperature of the print bed and/or the build material at a particular point in time when the image was captured over the period of time.

The surface flux engine 108 may include hardware and/or a combination of hardware and programming, but at least hardware, to determine a surface flux delivered to each of a plurality of zones of the print bed over the period of time. The print bed may be segmented into a plurality of zones. The segments may not be physical segments, but they may be theoretical segments defined for calibrating an overhead heat lamp. The segments may be a plurality of non-overlapping portions of the print bed such as in a grid pattern coinciding with the print bed. The plurality of zones may be defined by the surface flux engine 108.

As used herein, the surface flux corresponds to a quantity of energy (e.g., radiation, heat, etc.) received from an overhead heating lamp at a surface of the print bed over the period of time. As used herein, the surface of the print bed may include the surface of a build material selectively distributed on the print bed. For example, as part of a 3-D printing operation, build material may be placed on the print bed in a plurality of layers. The surface flux may include the quantity of heat received at the surface of a layer of the build material and/or at the surface of each of a plurality of layers of the build materials. The layers of the build material on the print bed may form a hotbed for starting the build of a part. One or more of the layers of build material may be a thermal margin layer which is ultimately sacrificed, but during the build serves to provide homogenous boundary conditions with higher temperature uniformity and less thermal gradients than a bare print bed. A layer that provides a thermal margin may be referred to as a sacrificial layer.

Determining the surface flux delivered to each of a plurality of zones of the print bed over the period of time may be based on a thermal evolution for each of the plurality of zones. As used herein, a thermal evolution may refer to a temperature profile over the period of time for a corresponding zone of the print bed. The temperature of a zone at a plurality of time points of the time period may be extracted from the temperature measurements included in the images of the print bed captured by the thermal imaging sensor. The extracted thermal profile for each of the plurality of zones may be fitted to a theoretical curve. In some examples, the thermal images and/or the thermal evolution extraction may occur during a 3-D printing operation of a part. That is, the system 100 may include an in-line solution to overhead heating lamp calibration that performs a calibration each time a part is printed and/or after a predetermined number of prints. As described above, the thermal images may be captured, over a period of time, of a single layer of sacrificial material on the print bed. In such examples, a time for completion of selectively distributing and/or warming a sacrificial layer of build material during operation may be extended to accommodate measurements over a length of time that will generate a smooth theoretical curve. In some examples, the time allotted for selectively distributing and/or heating a build material layer may be extended by approximately sixty seconds to accommodate the period of time. Alternatively, the thermal images may be captured over a period of time of a plurality of layers of sacrificial material that are laid on the print bed and/or heated during that period of time. While each additional layer of sacrificial material may create a perturbation through cooling, the theoretical curve may be normalized. For example, the curve may be smoothed by adjusting for the perturbations. In further examples, the thermal images may be captured, over a period of time, of a single layer or multiple layers of an unprinted portion of the build material on the print bed. In each of these examples, the thermal images may be captured during a build process for the 3-D printer.

In some examples the thermal evolution may be determined based at least in part on:

$${T}_{z = 0} ( t ) = {T}_{0} + \frac{Q}{h} \cdot θ ( t - {t}_{on} ) \cdot ( 1 - {e}^{{( \frac{h \sqrt{α}}{k} )}^{2} \cdot ( t - {t}_{on} )} \cdot erfc [ ( \frac{h \sqrt{α}}{k} ) \cdot \sqrt{t - {t}_{on}} ] ) + ( {T}_{∞} - {T}_{0} ) \cdot ( 1 - {e}^{{( \frac{h \sqrt{α}}{k} )}^{2} \cdot t} \cdot erfc [ ( \frac{h \sqrt{α}}{k} ) \cdot \sqrt{t} ] )$$

(Eq. 1). The thermal evolution may be expressed as a surface temperature as a function of time (T_{z=0}(t)) for a period of time. In some examples, Eq. 1 may utilize: an initial and semi-infinite boundary temperature (T₀), a convective boundary temperature (T_{∞}), a surface flux (Q), a convective heat transfer coefficient (h), a density of the building material in the print bed (p), an effective thermal conductivity (k), a thermal diffusivity (α)=(k/(p·cₚ)), and/or a unit step function (θ(t−†)). Apart from the material specific parameters described above, the temperature evolution may depend on the ratio of surface flux to convective transfer coefficient and the initial temperature T₀. The measured temperature profile may be fit to the theoretical curve for each of the zones.

The calibrate engine 110 may include hardware and/or a combination of hardware and programming, but at least hardware, to calibrate an overhead heating lamp of a plurality of overhead heating lamps in an array. The calibration may include a modification of an input to an overhead heating lamp based on a corresponding contribution to the surface flux of a zone by the overhead heating lamp. That is, the calibration may adjust the output of an overhead heating lamp by modifying a corresponding controlling input based on the contribution of the overhead lamp to a surface flux of a zone. Therefore, the temperature of the zone may be modified by modification to the output of an overhead heating lamp contributing a portion of the surface flux of that zone. It may be appreciated that through a concerted calibration of each of the plurality of overhead heating lamps in an array of overhead heating lamps, the surface flux and/or temperature of build material across the print bed may be brought into and/or maintained within approximate homogeneity. In some examples, approximate homogeneity may correspond to temperature of build material across the print bed being within a range of approximately ±10% of an overall average surface flux and/or temperature of the build material of the print bed. In some examples, the surface flux and/or temperature of build material across the print bed may be brought into and/or maintained within substantial homogeneity (e.g., within plus or minus two degrees Celsius of a particular set point or set points within a process window).

In an example, the system 100 may comprise a 3-D printing device. For example, a 3-D printer may cause to be executed and/or execute a number of engines (e.g., thermal image engine 106, surface flux engine 108, calibrate engine 110). The 3-D printing device may execute the system 100 utilizing integral, ancillary, and/or separate software, hardware, firmware, and/or logic to perform functions described herein.

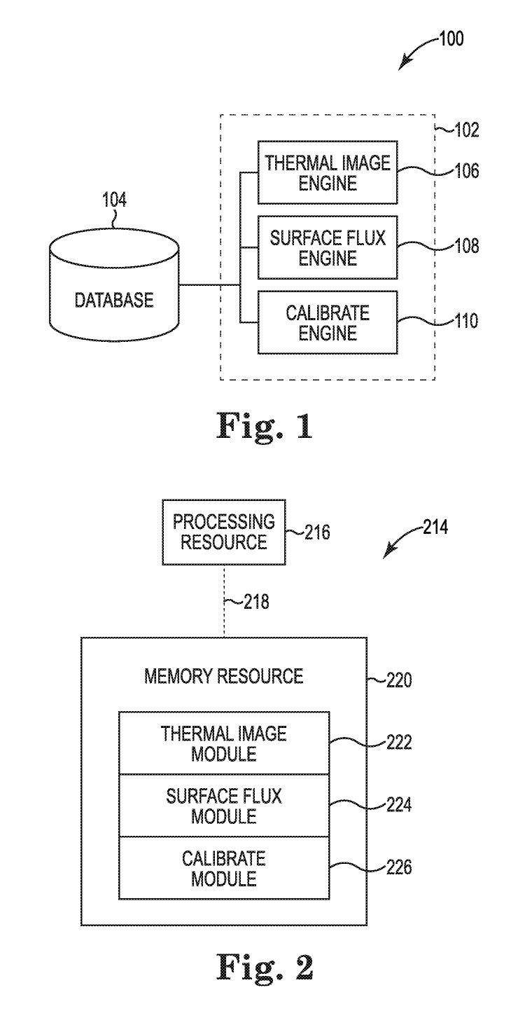

FIG. 2 illustrates a diagram of an example of a computing device 214 according to the present disclosure. The computing device 214 may utilize software, hardware, firmware, and/or logic to perform functions described herein.

The computing device 214 may be any combination of hardware and program instructions to share information. The hardware, for example, may include a processing resource 216 and/or a memory resource 220 (e.g., non-transitory computer-readable medium (CRM), machine readable medium (MRM), database, etc.). A processing resource 216, as used herein, may include any number of processors capable of executing instructions stored by a memory resource 220. Processing resource 216 may be implemented in a single device or distributed across multiple devices. The program instructions (e.g., computer readable instructions (CRI)) may include instructions stored on the memory resource 220 and executable by the processing resource 216 to implement a desired function (e.g., receive a plurality of thermal images of a print bed captured over a period of time, determine, from the plurality of thermal images, a surface flux delivered to the a zone of a plurality of zones of the print bed; generate a weighting matrix assigning a weight to a contribution of a heating lamp to the surface flux delivered to the zone; calibrate the heating lamp based on the contribution to the surface flux, etc.).

The memory resource 220 may be in communication with the processing resource 216 via a communication link (e.g., a path) 218. The communication link 218 may be local or remote to a machine (e.g., a computing device) associated with the processing resource 216. Examples of a local communication link 218 may include an electronic bus internal to a machine (e.g., a computing device) where the memory resource 220 is one of volatile, non-volatile, fixed, and/or removable storage medium in communication with the processing resource 216 via the electronic bus.

A number of modules (e.g., thermal image module 222, surface flux module 224, calibrate module 226, etc.) may include CRI that when executed by the processing resource 216 may perform functions. The number of modules (e.g., thermal image module 222, surface flux module 224, calibrate module 226, etc.) may be sub-modules of other modules. For example, the thermal image module 222 and the surface flux module 224 may be sub-modules and/or contained within the same device. In another example, the number of modules (e.g., thermal image module 222, surface flux module 224, calibrate module 226, etc.) may comprise individual modules at separate and distinct locations (e.g., CRM, etc.).

Each of the number of modules (e.g., thermal image module 222, surface flux module 224, calibrate module 226, etc.) may include instructions that when executed by the processing resource 216 may function as a corresponding engine as described herein. For example, the thermal image module 222, surface flux module 224, and calibrate module 226 may include instructions that when executed by the processing resource 216 may function as the thermal image engine 106, the surface flux engine 108, and the calibrate engine 110, respectively.

The thermal image module 222 may include a non-transitory computer readable medium storing instructions executable by a processing resource to cause a computer (such as the computing device 214 of FIG. 2) to receive a plurality of thermal images of a print bed captured over a period of time. The plurality of thermal images may include thermal images of an uppermost surface of a build material making up a sacrificial layer selectively distributed upon the print bed.

The surface flux module 224 may include a non-transitory computer readable medium storing instructions executable by a processing resource to determine, from the plurality of thermal images, a surface flux delivered to the zone of the print bed. The surface flux delivered the zone (Q_{Zone1}) may be determined based on a thermal evolution for the zone extracted from the thermal images. The surface flux delivered to each of a plurality of zones (Q_{Zone1} . . . Q_{Zonen}) may be determined based on the thermal evolution for each of the plurality of zones extracted from the thermal images.

The surface flux module 224 may include a non-transitory computer readable medium storing instructions executable by a processing resource to generate a weighting matrix assigning a weight to a contribution of a heating lamp to the surface flux delivered to the zone. Generating the weighting matrix may include assigning a weight to the contribution of each of a plurality of overhead heating lamps of an array to each of a plurality of zones of the print bed. Generating the weight matrix may include measuring an irradiance distribution profile of the overhead heating lamp. The irradiance distribution profile may be generated utilizing an experimental method to measure the energy (e.g., heat energy, radiation energy, radiated energy, etc.) that is being output by the overhead heating lamp. The irradiance distribution profile may be based on a measurement of the energy emitted from an overhead heating lamp captured utilizing a power measurement tool such as a power densitometer.

The irradiance distribution profile may include a radiation profile that may be mapped to a portion of the print bed. The irradiance distribution profile may be mapped to a particular portion of the print bed, which may correspond to a zone or zones, utilizing a physical topology of the heating lamp in an array over the print bed. For example, the irradiance distribution profile for the overhead heating lamp may be aligned in an orientation corresponding to the orientation of the overhead heating lamp in an overhead heating lamp array. Additionally, the irradiance distribution profile may be mapped to a portion of the print bed corresponding to an area that would receive the radiation based on the spatial relationship between the portion of the print bed and the heating lamp (e.g., the portion of the print bed centered under the heating lamp occupying the space directly under the heating lamp that would receive the heat generated by the heating lamp). Since a single zone may be receiving radiation from a plurality of overhead heating lamps, the weighting matrix may assign a weight to a contribution of each of the plurality of overhead heating lamps to each of a plurality of zones. The weight of a contribution of a heating lamp to the surface flux delivered to a zone may be calculated as the average value of surface flux in that zone. The weight of a contribution of a heating lamp to the surface flux of a particular zone may be determined based on the contribution of radiation from the heating lamp determined from the irradiance distribution profile of the heating lamp and the physical arrangement of the heating lamp in the array in relation to the print bed zones.

A linear relationship may exist between the radiated lamp power and the power measured in each zone as surface flux. A linear equation may be utilized to define the relationship between surface flux delivered to a zone, the weighting matrix, and a radiated lamp power. In some examples, a linear equation to define the relationship between surface flux delivered to a zone, the weighting matrix, and a radiated lamp power may be expressed as:

$$[ \begin{matrix}{Q}_{{Zone}_{1}} \\ {Q}_{{Zone}_{2}} \\ ⋮ \\ {Q}_{{Zone}_{n}}\end{matrix} ] = [ \begin{matrix}{w}_{{L}_{1} {Z}_{1}} & {w}_{{L}_{2} {Z}_{1}} & … & {w}_{{L}_{m} {Z}_{1}} \\ {w}_{{L}_{1} {Z}_{2}} & {w}_{{L}_{2} {Z}_{2}} & … & {w}_{{L}_{m} {Z}_{2}} \\ ⋮ & ⋮ & & ⋮ \\ {w}_{{L}_{1} {Z}_{n}} & {w}_{{L}_{2} {Z}_{n}} & … & {w}_{{L}_{m} {Z}_{n}}\end{matrix} ] \cdot [ \begin{matrix}{P}_{{Lamp}_{1}} \\ {P}_{{Lamp}_{2}} \\ ⋮ \\ {P}_{{Lamp}_{m}}\end{matrix} ]$$

(Eq. 2). Eq. 2 may include the surface flux delivered a zone (Q_{Zone}), the weighting matrix including the weight (w) of a contribution of each of the overhead heating lamps (L) in an overhead heating lamp assembly to a plurality of zones (Z) of the print bed, and the radiated power (P) of each overhead heating lamp (Lamp) of the plurality of overhead heating lamps making up the overhead heating lamp assembly.

The radiated lamp power may include the amount of energy (e.g., heat energy, radiation energy, radiated energy, etc.) that a particular lamp is contributing to each of the zones of a print bed. Since the surface flux for each zone is already determined, the radiated lamp power may be calculated by solving the inverse of Eq.2:

$$[ \begin{matrix}{P}_{{Lamp}_{1}} \\ {P}_{{Lamp}_{2}} \\ ⋮ \\ {P}_{{Lamp}_{m}}\end{matrix} ] = {[ \begin{matrix}{w}_{{L}_{1} {Z}_{1}} & {w}_{{L}_{2} {Z}_{1}} & … & {w}_{{L}_{m} {Z}_{1}} \\ {w}_{{L}_{1} {Z}_{2}} & {w}_{{L}_{2} {Z}_{2}} & … & {w}_{{L}_{m} {Z}_{2}} \\ ⋮ & ⋮ & & ⋮ \\ {w}_{{L}_{1} {Z}_{n}} & {w}_{{L}_{2} {Z}_{n}} & … & {w}_{{L}_{m} {Z}_{n}}\end{matrix} ]}^{- 1} \cdot [ \begin{matrix}{Q}_{{Zone}_{1}} \\ {Q}_{{Zone}_{2}} \\ ⋮ \\ {Q}_{{Zone}_{n}}\end{matrix} ]$$

(Eq. 3). In some examples, matrix inversion may not provide expected results as negative emissivity valued may be implied. As an alternative, the equation may be solved with a non-negative least square fitting formula.

The calibrate module 226 may include non-transitory computer readable medium storing instructions executable by a processing resource to cause a computer (such as the computing device 214 of FIG. 2) to calibrate the heating lamp based on the weighted contribution to the surface flux. For example, the heating lamp may be calibrated by adjusting the radiated lamp power for the heating lamp by modifying power delivered to the heating lamp. Therefore, in some examples, calibrating a heating lamp may comprise modifying power delivered to the heating lamp based at least in part on the weighted contribution of the surface flux of the lamp.

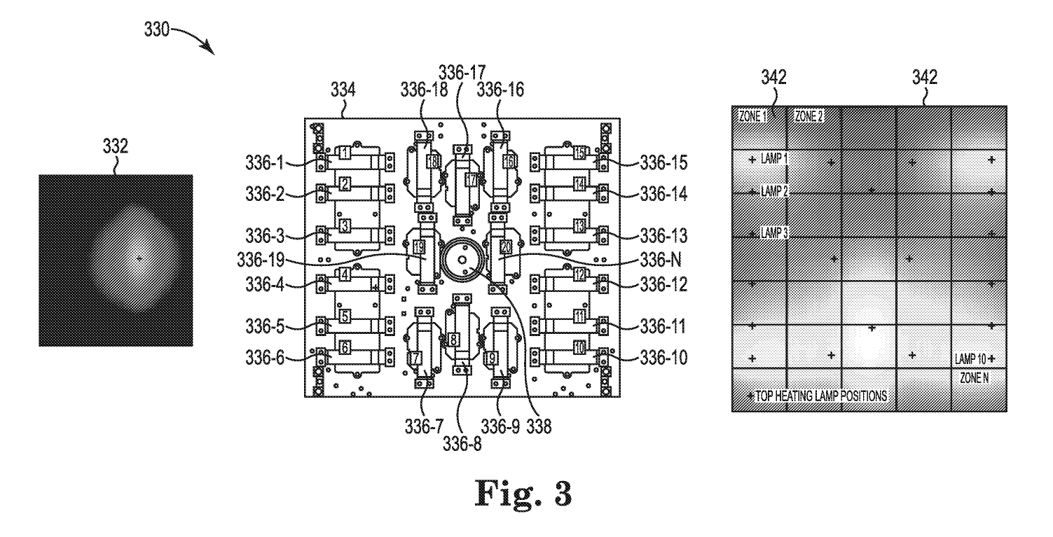

FIG. 3 illustrates a diagram of an example of a system 330 for generating a weighting matrix for heating lamp calibration according to the present disclosure. In some examples, the system 330 may be utilized with an additive manufacturing system such as three-dimensional (3-D) printing system. In some examples, the system 330 may be utilized with a computing device such as computing device 214 as referenced in FIG. 2.

The system 330 may include an irradiance distribution profile 332 for an overhead heating lamp. An irradiance distribution profile 332 may be a radiation profile of a single overhead lamp measured utilizing a power densitometer. The irradiance distribution profile 332 may be illustrated as a heat map where the lightest portions of the irradiance distribution profile 332 correspond to a highest level of emitted radiation.

The system 330 may include a physical topology map 334 of an overhead heating lamp assembly. The overhead heating lamp assembly may include a plurality of overhead heating lamps 336-1 . . . 336-N. The overhead heating lamp assembly may include a thermal imaging sensor 338. The overhead heating assembly may be mounted in a substantially fixed position above a print bed.

The system 330 may include a composed radiation profile 340 for a plurality of overhead heating lamps. For example, the composed radiation profile 340 may include a plurality of crosses showing the positions on the profile corresponding to each of the plurality of overhead heating lamps. The composed radiation profile 340 may be generated by positioning and orienting the irradiance distribution profile 332 of each of a plurality of overhead heat lamps (e.g., 336-1, 336-6, 336-8, 336-10, and 336-15) on the composed radiation profile 340 according to the physical topology of the corresponding overhead heat lamps on the physical topology map 334 of the overhead heating lamp assembly. Additionally, the composed radiation profile 340 may include a plurality of zones corresponding to the plurality of zones of the print bed. Since the overhead heating lamp assembly may be substantially fixed above the print bed the correlation between the zones of the print bed and the portions of the composed radiation profile 340 may be accurately determined from the alignment of the physical topology map 334 of the overhead heating lamp assembly with the segmented print bed. The composed radiation profile 340 may be illustrated as a heat map where the lightest portions of the irradiance distribution profile 332 correspond to a highest level of emitted radiation.

The system 330 may be utilized to develop a weighting matrix assigning a weight to the contribution of each of a plurality of overhead heating lamps to each of a plurality of zones. For example, the contribution of an overhead heating lamp to a zone may be calculated as the average value of surface flux measured in the zone. The contribution of an overhead heating lamp to a zone may be determined based on the composed radiation profile 340.

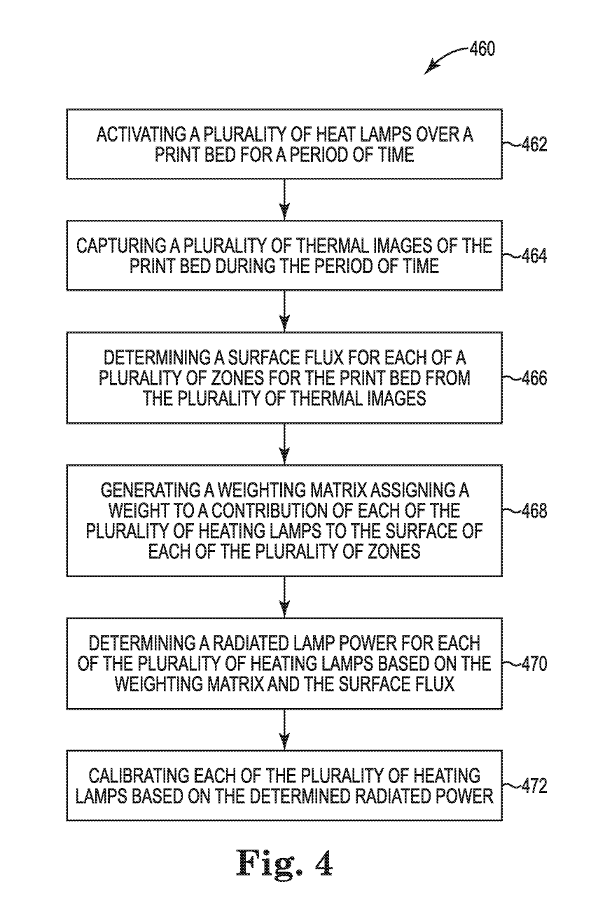

FIG. 4 illustrates a flowchart of an example method 460 of heating lamp calibration according to the present disclosure. In some examples, the method 460 may be executed by a computing device and/or system as described herein. For example, the method 460 may be executed by a computing device 214 as referenced in FIG. 2. In some examples, the method 460 may be utilized to calibrate a number of overhead heating lamps utilizing a sacrificial layer of build material and/or an unprinted portion of build material on a print bed of a 3-D printing device.

At 462, the method 460 may include activating a plurality of heat lamps over a print bed for a period of time. Activating the plurality of heat lamps may include turning on (i.e., delivering power to) the plurality of heat lamps so that they begin to radiate energy (e.g., heat energy, radiation energy, radiated energy, etc.) and so that the energy is received by portions of the print bed including layers of build material.

At 464, the method 460 may include capturing a plurality of thermal images of the print bed during the period of time. Capturing the plurality of thermal images of the print bed may include capturing images including temperature data of a surface of build material on the print bed over the course of the period of time.

At 466, the method 460 may include determining a surface flux for each of a plurality of zones of the print bed from the plurality of thermal images. The surface flux for the plurality of zones may be based on a temperature evolution for each of the zones extracted from the plurality of thermal images.

At 468, the method 460 may include generating a weighting matrix assigning a weight to a contribution of each of the plurality of heating lamps to the surface of each of the plurality of zones. The weight matrix may be based on a an irradiance distribution profile and a physical topology of the overhead heat lamps in an overhead heating lamp array.

At 470, the method 460 may include determining a radiated lamp power for each of the plurality of heating lamps. The radiated lamp power for each of the plurality of heating lamps may be determined based on the weighting matrix and the surface flux. The radiated lamp power may be determined by solving a linear equation system utilizing the weighting matrix and/or the surface flux delivered to each zone of the print bed.

At 472, the method 460 may include calibrating each of the plurality of heating lamps based on the determined radiated lamp power. Calibrating each of the plurality of heating lamps may include adjusting the power delivered to each heating lamp to modify the radiated lamp power of the heating lamp. The calibration may include adjusting the power delivery to each of the plurality of heating lamps to generate a flat temperature profile at a given temperature set point. That is, the calibration may include adjusting the power delivery to each of the plurality of heating lamps to generate a substantially homogenous temperature of the print bed. For example, the calibration may include adjusting the power delivery to each of the plurality of heating lamps to maintain a temperature within plus or minus two degrees Celsius of a particular set point or set points within a process window.

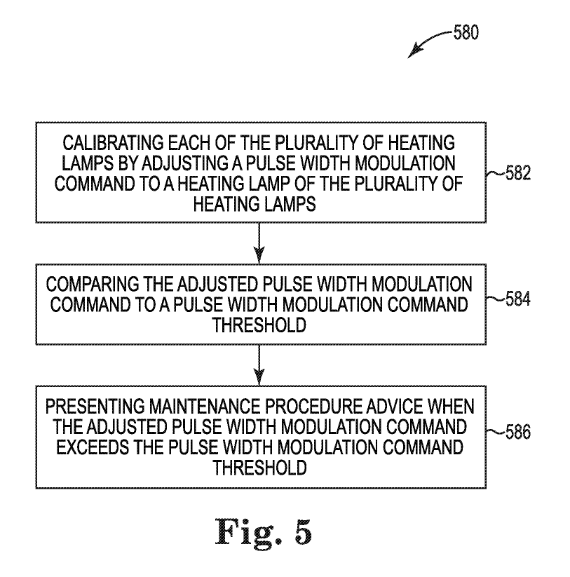

FIG. 5 illustrates an example sequence of operations to calibrate the heating lamps according to the present disclosure. In some examples, the method 580 may be executed by a computing device and/or system as described herein. For example, the method 580 may be executed by a computing device 214 as referenced in FIG. 2. In some examples, the method 580 may be utilized to calibrate a number of overhead heating lamps utilizing a sacrificial layer of build material, a calibration surface of a print bed, and/or an unprinted portion of build material on a print bed of a 3-D printing device.

At 582, the method 580 may include calibrating each of the plurality of heating lamps by adjusting a pulse width modulation command to a heating lamp of the plurality of heating lamps. Pulse width modulation commands may include a signal that may be modulated between a pulse width of zero to one. A pulse width command signal with a pulse width value of one may indicate that the heating lamp is switched on for the full period of time. A pulse width command signal with a pulse width value of zero may indicate that the heating lamp is switched off the full period of time.

At 584, the method 580 may include calibrating each of the plurality of heating lamps by comparing the adjusted pulse width modulation command to a pulse width modulation command threshold. The pulse width modulation command threshold may include a pulse width value of one. Since a pulse width value of one may be indicative of a heating lamp switched on for the full period of time, it may also be indicative of a maximum amount of radiated power possible from the heating lamp.

At 586, the method 580 may include presenting maintenance procedure advice when the adjusted pulse width modulation command exceeds the pulse width modulation command threshold. For example, higher radiated power may be desired from a heating lamp that is already receiving a pulse width modulation command with a pulse width modulation value of one. In order to produce a higher radiated power in such an example the calibration may involve more than simply modifying a pulse width modulation command. For example, achieving the higher radiated power when the adjusted pulse width modulation command exceeds the pulse width modulation command threshold may involve performing maintenance on a portion of the 3-D printing device. In these examples, calibrating each of the plurality of heating lamps may include presenting maintenance procedure advice via a user interface. Maintenance procedure advice may include identifying components that may need repair, cleaning, or replacement along with instructions for accomplishing the tasks. For example, the maintenance procedure advice may include identifying a heating lamp that should be replaced along with instructions on replacing it. In another example, the maintenance procedure advice may include instructions on cleaning the optics of the 3-D printing device.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something may refer to one or more such things. For example, “a number of widgets” may refer to one or more widgets.

The figures herein follow a numbering convention in which the first digit or digits correspond to the drawing figure number and the remaining digits identify an element or component in the drawing. As will be appreciated, elements shown in the various examples herein may be added, exchanged, and/or eliminated so as to provide a number of additional examples of the present disclosure. In addition, as will be appreciated, the proportion and the relative scale of the elements provided in the figures are intended to illustrate certain examples of the present disclosure, and should not be taken in a limiting sense.

The above specification, examples and data provide a description of the method and applications, and use of the system and method of the present disclosure. Since many examples may be made without departing from the spirit and scope of the system and method of the present disclosure, this specification merely sets forth some of the many possible example configurations and implementations.

What is claimed is:

1. A system, comprising:
a plurality of heating lamps over a print bed to heat the print bed over a period of time;
a thermal imaging sensor to capture images of the print bed over the period of time; and
a computing device coupled to the thermal imaging sensor to:
determine a surface flux delivered to each of a plurality of zones of the print bed over the period of time; and
calibrate a heating lamp of the plurality of heating lamps based on a corresponding contribution to the surface flux.

2. The system of claim 1, wherein the surface flux corresponds to a quantity of heat received over the period of time at a surface of a sacrificial layer of build material selectively distributed on the print bed.

3. The system of claim 1, wherein the surface flux corresponds to a quantity of heat received over the period of time at an unprinted region of build material selectively distributed on the print bed.

4. The system of claim 1, wherein the computing device to determine the surface flux to each of the plurality of zones comprises the computing device to determine the surface flux for each of the plurality of zones based at least in part on an image of a calibration surface captured by the thermal imaging sensor.

5. The system of claim 1, wherein the thermal imaging sensor captures images during a build process.

6. The system of claim 1, wherein the computing device to determine the surface flux to each of the plurality of zones comprises the computing device to determine the surface flux for each of the plurality of zones based at least in part on a thermal evolution for each of the plurality of zones.

7. The system of claim 6, wherein the computing device to determine the surface flux to each of the plurality of zones based at least in part on the thermal evolution for each of the plurality of zones comprises the computing device to determine the surface flux for each of the plurality of zones based at least in part on the thermal evolution for each of the plurality of zones extracted from temperature measurements included in the images of the print bed captured by the thermal imaging sensor.

8. A non-transitory computer readable medium storing instructions executable by a processing resource to cause a computer to:
receive a plurality of thermal images of a print bed captured over a period of time;
determine, from the plurality of thermal images, a surface flux delivered to a zone of the print bed;
generate a weighting matrix assigning a weight to a contribution of a heating lamp to the surface flux delivered to the zone; and
calibrate the heating lamp based on the weighted contribution to the surface flux.

9. The non-transitory computer readable medium of claim 8, comprising instructions to generate the weighting matrix utilizing a measured irradiance distribution profile of the heating lamp.

10. The non-transitory computer readable medium of claim 8, comprising instructions to generate the weighting matrix utilizing a physical topology of the heating lamp in a heating lamp array over the print bed.

11. The non-transitory computer readable medium of claim 8, comprising instructions to determine a radiated lamp power of the heating lamp based on the weight assigned to the contribution of the heating lamp to the zone and the determined surface flux delivered to the zone.

12. A method of heating lamp calibration for a three-dimensional (3-D) printer, comprising:
activating a plurality of heat lamps over a print bed for a period of time;
capturing a plurality of thermal images of the print bed during the period of time;
determining a surface flux for each of a plurality of zones of the print bed from the plurality of thermal images;
generating a weighting matrix assigning a weight to a contribution of each of the plurality of heating lamps to the surface of each of the plurality of zones;
determining a radiated lamp power for each of the plurality of heating lamps based on the weighting matrix and the surface flux; and
calibrating each of the plurality of heating lamps based on the determined radiated power.

13. The method of claim 12, comprising calibrating each of the plurality of heating lamps to generate a substantially homogenous temperature of the print bed.

14. The method of claim 12, comprising calibrating each of the plurality of heating lamps by adjusting a pulse width modulation command to a heating lamp of the plurality of heating lamps.

15. The method of claim 14, comprising comparing the adjusted pulse width modulation command to a pulse width modulation command threshold.

16. The method of claim 15, comprising presenting maintenance procedure advice when the adjusted pulse width modulation command exceeds the pulse width modulation command threshold.
